(19) United States
(12) Patent Application Publication
(10) Pub. No.: US 2026/0138540 A1
(43) Pub. Date: May 21, 2026

(54) BRACKET

(71) Applicant: PIOLAX, INC., Kanagawa (JP)

(72) Inventors: Yasushi KUMAKAWA, Kanagawa (JP); Atsushi SOGABE, Kanagawa (JP)

(73) Assignee: PIOLAX, INC., Kanagawa (JP)

(21) Appl. No.: 19/384,392

(22) Filed: Nov. 10, 2025

(30) Foreign Application Priority Data
Nov. 18, 2024 (JP) 2024-200973

(51) Int. Cl. B60R 11/00

(52) U.S. Cl. CPC B60R 11/00; B60R 2011/004; B60R 2011/0071

(57) ABSTRACT

There is provided a bracket for attaching, to a vehicle, a detection device including a main body and first protruding portions. The bracket includes: an opening; first holding portions; and a locking portion. Each of the first holding portions includes: a first seating surface; and a retaining portion forming an insertion port. The first seating surface includes an edge portion forming a part of the insertion port. The edge portion is configured to guide an insertion of one of the first protruding portions when the detection device is attached, and configured to serve as a rotation pivot for rotating the one of the first protruding portions in a direction of seating the one of the first protruding portions on the first seating surface after guiding the insertion of the one of the first protruding portions.

### CROSS-REFERENCE TO RELATED APPLICATIONS

This application is based on and claims priority under 35 USC § 119 from Japanese Patent Application No. 2024-200973 filed on Nov. 18, 2024, the contents of which are incorporated herein by reference.

### TECHNICAL FIELD

The present disclosure relates to a bracket for attaching a detection device to a vehicle.

### BACKGROUND

A detection device including a detector for detecting surrounding environment of a vehicle and a bracket for attaching the detector to a vehicle body is disclosed in the JP2020-91260A (PTL 1). The bracket includes a bottom wall portion facing a rear surface portion of the detector, a side wall portion erected from the bottom wall portion, and a protrusion protruding from the side wall portion. When the detector is rotated to be attached, an end portion of the detector is brought into contact with the bottom wall portion and the protrusion of the side wall portion, and then guided from a guiding portion of the protrusion to a positioning portion of the protrusion.

With the technology described in PTL 1, when attaching the detector, the detector is inserted obliquely to the bottom wall portion and the side wall portion, then after the end portion of the detector is brought into contact with the bottom wall portion and the protrusion, the detector is rotated. Improving the guidability for oblique insertion of the detector is desired.

An object of the present disclosure is to provide a bracket that can improve the attaching workability of a detection device.

### SUMMARY

There is provided a bracket for attaching, to a vehicle, a detection device including a main body and first protruding portions respectively formed on both sides of the main body and protruding in a width direction. The bracket includes: an opening configured to expose a detection surface of the detection device; first holding portions formed in pairs on both sides of the opening and capable of holding the first protruding portions; and a locking portion configured to lock with the main body. Each of the first holding portions includes: a first seating surface on which one of the first protruding portions can be seated; and a retaining portion forming an insertion port in cooperation with the first seating surface for inserting a part of the one of the first protruding portions when attaching the detection device to the bracket, and capable of sandwiching and holding the one of the first protruding portions between the retaining portion and the first seating surface. The locking portion is configured to restrict a movement of the detection device away from the first seating surface when the detection device is completely attached. The first seating surface includes an edge portion forming a part of the insertion port. The edge portion is configured to guide an insertion of the one of the first protruding portions when the detection device is attached, and configured to serve as a rotation pivot for rotating the one of the first protruding portions in a direction of seating the one of the first protruding portions on the first seating surface after guiding the insertion of the one of the first protruding portions.

### BRIEF DESCRIPTION OF DRAWINGS

FIG. 1 is a perspective view of an attachment structure with a detection device attached to a bracket according to an embodiment, as seen from a surface side.

FIG. 2 is a perspective view of the attachment structure of the bracket and the detection device, as seen from a rear side.

FIG. 3 is a rear view of the detection device.

FIG. 4 is a rear view of the bracket according to an embodiment.

FIG. 5 is a cross-sectional view of the bracket shown in FIG. 4 taken along a line A-A.

FIG. 6 is a diagram provided to explain an insertion process during a process of attaching the detection device to the bracket.

FIG. 7 is a diagram provided to explain a rotation process during the process of attaching the detection device to the bracket.

FIG. 8 is a partial perspective view of the bracket according to a modification.

FIG. 9 is a partial cross-sectional view of the attachment structure in a state in which the detection device is completely attached on the bracket.

### DESCRIPTION OF EMBODIMENTS

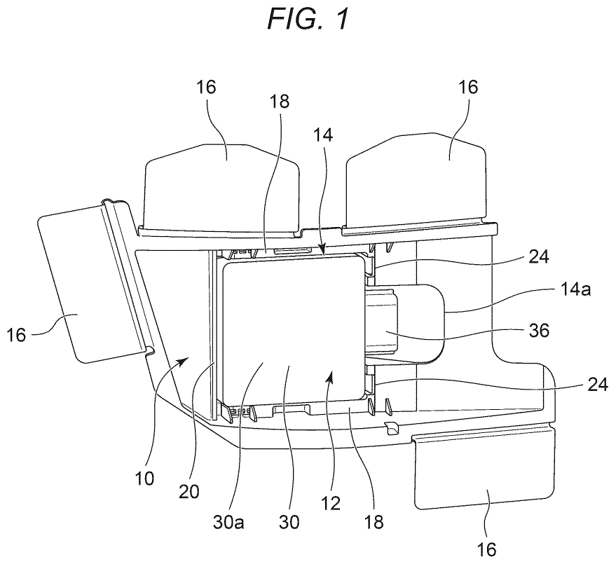

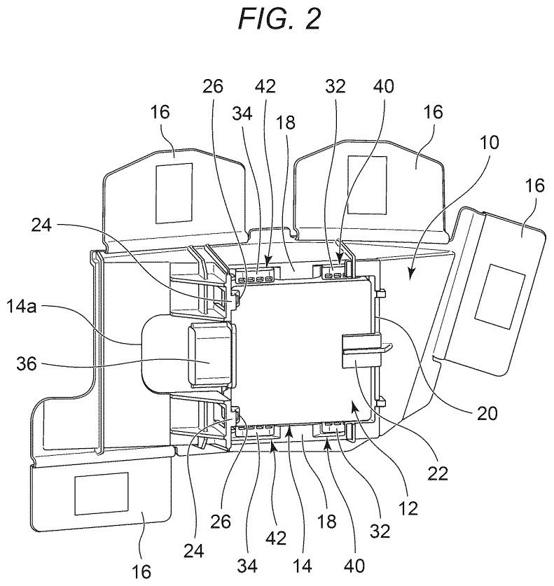

FIG. 1 is a perspective view of an attachment structure 1 with a detection device 12 attached to a bracket 10 according to an embodiment, as seen from a surface side. FIG. 2 is a perspective view of the attachment structure 1 of the bracket 10 and the detection device 12, as seen from a rear side.

The attachment structure 1 is fixed to a rear surface of an exterior panel of a vehicle, such as a front grille, a front bumper, and a rear bumper, with a detection surface 30a of the detection device 12 exposed. The attachment structure 1 includes the detection device 12 and the bracket 10 for fixing the detection device 12 to the vehicle.

The detection device 12 is an object detection device provided on the vehicle to detect objects present around the vehicle, and is a millimeter wave radar, for example. The attachment structure 1 may be provided at both corners of a front portion of the vehicle or at both corners of a back portion of the vehicle, respectively.

The bracket 10 includes an opening 14, blade portions 16, side wall portions 18, a front wall portion 20, a restricting portion 22, a rear wall portion 24, an elastic locking portion 26, first holding portions 40 and second holding portions 42.

The attachment structure 1 shown in FIG. 1 is a side that is attached to the rear surface of the exterior panel of the vehicle. Surfaces of a plurality of blade portions 16 shown in FIG. 1 are fixed so as to adhere to the rear surface of the exterior panel. The bracket 10 includes the opening 14, and the detection device 12 is disposed in the opening 14. The detection device 12 exposes the detection surface 30a from the opening 14.

The detection device 12 may be attached to the bracket 10 fixed to the exterior panel from the rear side of the bracket 10 shown in FIG. 2. Each configuration of the attachment structure 1 is described with reference to another drawing.

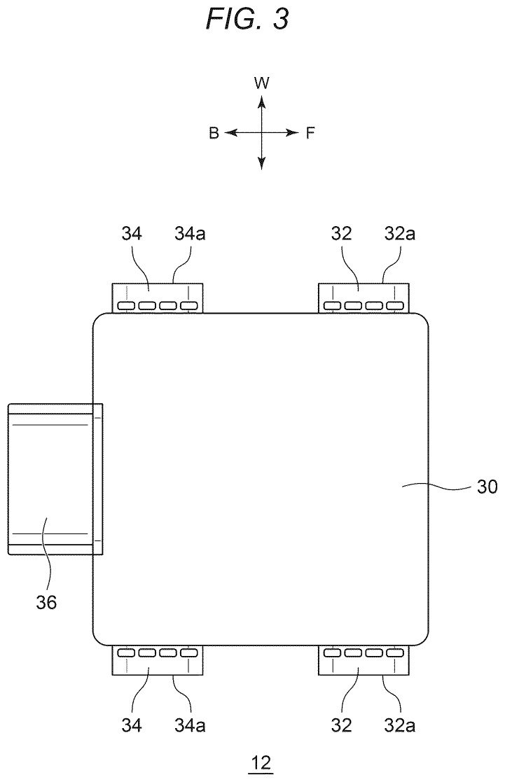

FIG. 3 is a rear view of the detection device 12. The detection device 12 includes a main body 30, first protruding portions 32, second protruding portions 34, and a connection portion 36. The main body 30 is formed as a cube. The first protruding portions 32 are respectively formed on both sides of the main body 30 and protrude in a width direction W. The first protruding portion 32 includes a first side surface 32a positioned on the outer side in the width direction W of the first protruding portion 32.

The second protruding portions 34 are respectively formed on both sides of the main body 30 and protrude in the width direction W. The second protruding portions 34 are positioned behind the first protruding portion 32 and in a back direction B. The first protruding portions 32 and the second protruding portions 34 are positioned side by side in a front-back direction F-B. The front direction F and the back direction B are perpendicular to the width direction W. The second protruding portion 34 includes a second side surface 34a positioned on the outer side in the width direction W of the second protruding portion 34. The pair of first protruding portions 32 and the pair of second protruding portions 34 protrude from the main body 30 by the same length in the width direction W.

The connection portion 36 is formed on a back portion of the main body 30 and is formed so as to protrude toward the back direction B. The connection portion 36 is connected to a communicable cable or the like.

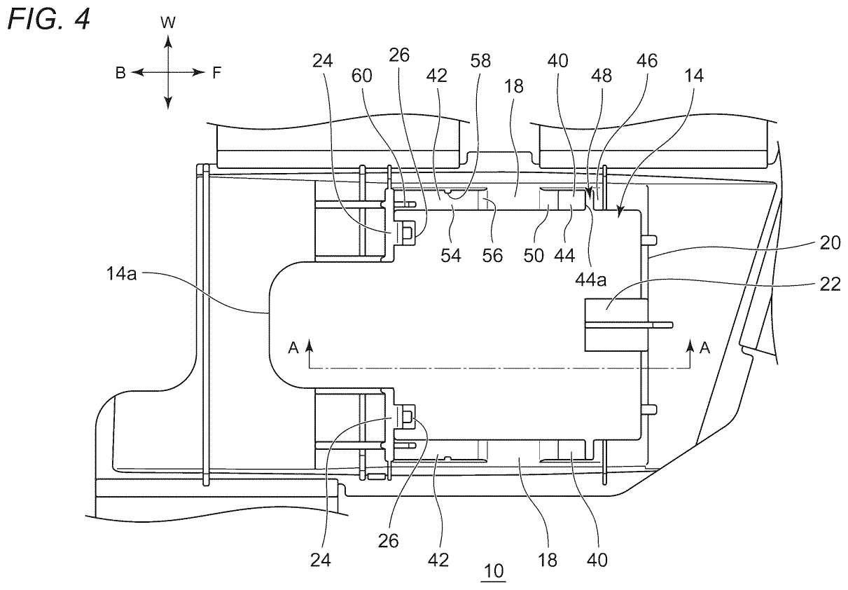

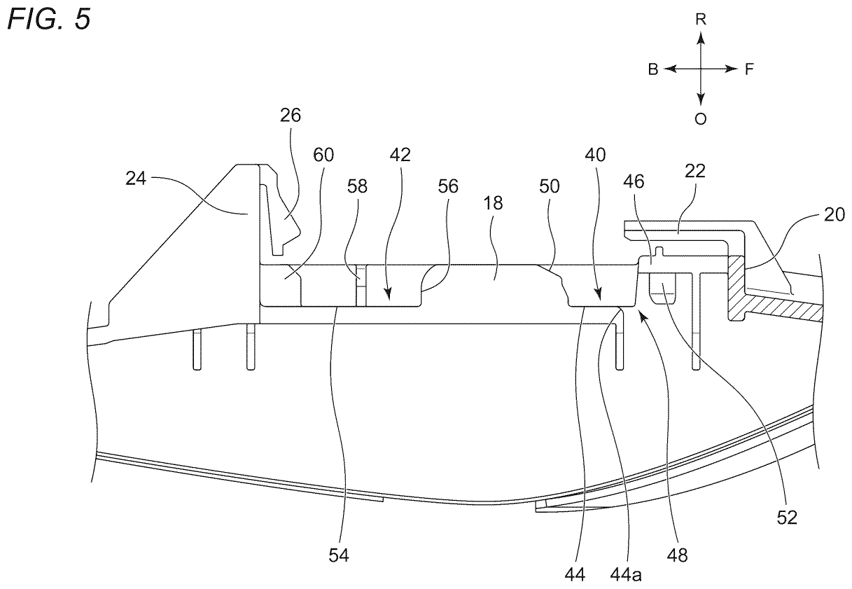

FIG. 4 is a rear view of the bracket 10 according to an embodiment. FIG. 5 is a cross-sectional view of the bracket 10 shown in FIG. 4 taken along a line A-A. The opening 14 includes a notch portion 14a formed by cutting away one side of a rectangle. The opening 14 is defined by a pair of side wall portions 18, the front wall portion 20 and the restricting portion 22. The pair of side wall portions 18 face each other.

The restricting portion 22 extends from the front wall portion 20 in the back direction B. An elastic locking portion 26 is formed in pairs on the rear wall portion 24. The notch portion 14a is formed between the pair of elastic locking portions 26. The elastic locking portion 26 is flexible in the front-back direction F-B and can be locked to a back end portion of the main body 30. The elastic locking portion 26 may not have elasticity and may simply serve as a locking portion, and, for example, may be in a claw shape without elasticity.

The first holding portion 40 is formed on each of the pair of side wall portions 18 positioned on both sides of the opening 14, and holds the first protruding portion 32. The second holding portion 42 is formed on each of the pair of side wall portions 18 positioned on both sides of the opening 14, and holds the second protruding portion 34.

The first holding portion 40 and the second holding portion 42 are formed on an inner surface of the side wall portion 18. The first holding portion 40 includes a first seating surface 44, a retaining portion 46, an insertion port 48, an inclined portion 50, and a first rib 52.

The first seating surface 44 is formed in a planar shape to protrude from the inner surface of the side wall portion 18 and is positioned behind the restricting portion 22 and in the back direction B. The first seating surface 44 includes an edge portion 44a in the front direction B. An insertion space is formed from the edge portion 44a in a surface direction O. The inclined portion 50 is formed so as to rise from an edge of the first seating surface 44 in the back direction B and serves as a guide for guiding the first protruding portion 32 to the first holding portion 40. The inclined portion 50 is inclined toward the insertion port 48. The surface-rear direction O-R are perpendicular to the front-back direction F-B.

The retaining portion 46 protrudes from the inner surface of the side wall portion 18 and is positioned apart from the first seating surface 44 in the rear direction R. The edge portion 44a and the retaining portion 46 form the insertion port 48 into which a portion of the first protruding portion 32 can be inserted when the detection device 12 is attached to the bracket 10. The first rib 52 is formed to protrude from the inner surface of the side wall portion 18 and is positioned on a surface side of the retaining portion 46.

The second holding portion 42 includes a second seating surface 54, a regulation portion 56, a second rib 58, and a stopper 60. The second seating surface 54 is formed in a planar shape protruding from the inner surface of the side wall portion 18, and is positioned behind the first seating surface 44 and in the back direction B.

The regulation portion 56 rises from the front edge of the second seating surface 54 toward the rear direction R. The stopper 60 rises from the back portion of the second seating surface 54 toward the rear direction R. The regulation portion 56 and the stopper 60 regulate the movement of the second protruding portion 34 housed in the second holding portion 42 in the front-back direction F-B. The second rib 58 is formed between the regulation portion 56 and the stopper 60 and is formed to protrude from the inner surface of the side wall portion 18.

As shown in FIG. 2, the first protruding portion 32 is housed and held in the first holding portion 40. The second protruding portion 34 is housed and held in the second holding portion 42. By holding the first protruding portion 32 and the second protruding portion 34, the first holding portion 40 and the second holding portion 42 can be disposed not to overlap with the detection surface 30a. The elastic locking portion 26 locks the back portion of the main body 30 to restrict the detection device 12 from being released from the held state. The restricting portion 22 may not always need to be in contact with the main body 30, but restricts the detection device 12 from being released from the held state. By providing the restricting portion 22 and the elastic locking portion 26 on the rear side, the restricting portion 22 and the elastic locking portion 26 can be disposed so as not to overlap with the detection surface 30a on the surface side.

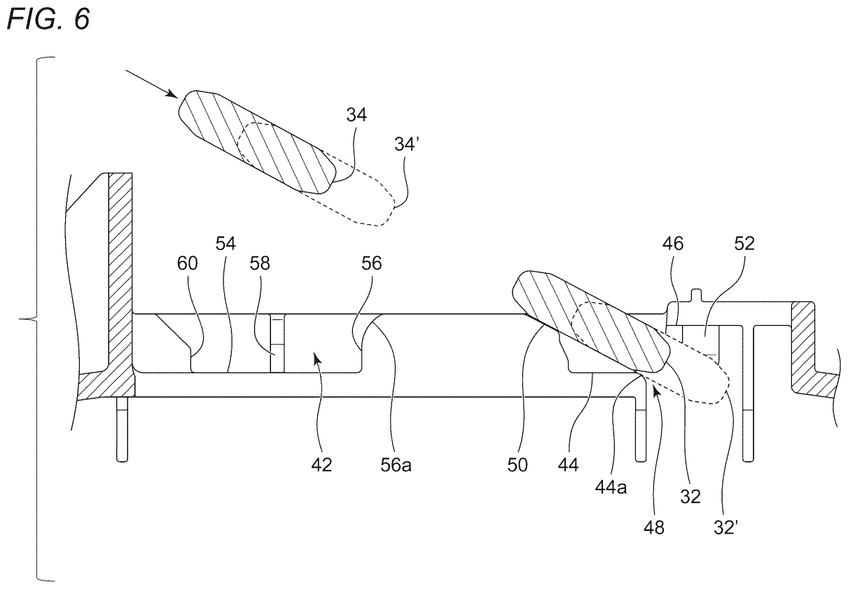

FIG. 6 is a diagram provided to explain an insertion process during a process of attaching the detection device 12 to the bracket 10. The bracket 10 may be either before or after being attached on the exterior panel of the vehicle. FIG. 6 shows the first protruding portion 32 and the second protruding portion 34 of the detection devices 12, in which the first protruding portion 32 and the second protruding portion 34 are moved to the first protruding portion 32′ and the second protruding portion 34′ during the attaching process. The detection device 12 is moved toward the front direction F by insertion. Therefore, the front direction F may be referred to as the insertion direction.

The first protruding portion 32 is positioned by being brought into contact with the inclined portion 50, and further inserted toward the insertion port 48 by being brought into contact with the edge portion 44a. The edge portion 44a forms a part of the insertion port 48 to guide the insertion of the first protruding portion 32 when the detection device 12 is attached. In such a manner, the inclined portion 50 and the edge portion 44a serve as the insertion guide of the first protruding portion 32, and a part of the first protruding portion 32 can be easily inserted into the interior of the retaining portion 46. The insertion of the detection device 12 is stopped when the main body 30 comes into contact with the front wall portion 20.

In the insertion process, the first side surface 32a of the first protruding portion 32 comes into contact with the first rib 52. That is, the first rib 52 abuts against the first side surface 32a when the first protruding portion 32 is inserted. A position of the detection device 12 in the width direction can be determined by the pair of first protruding portions 32 contacting a pair of first ribs 52.

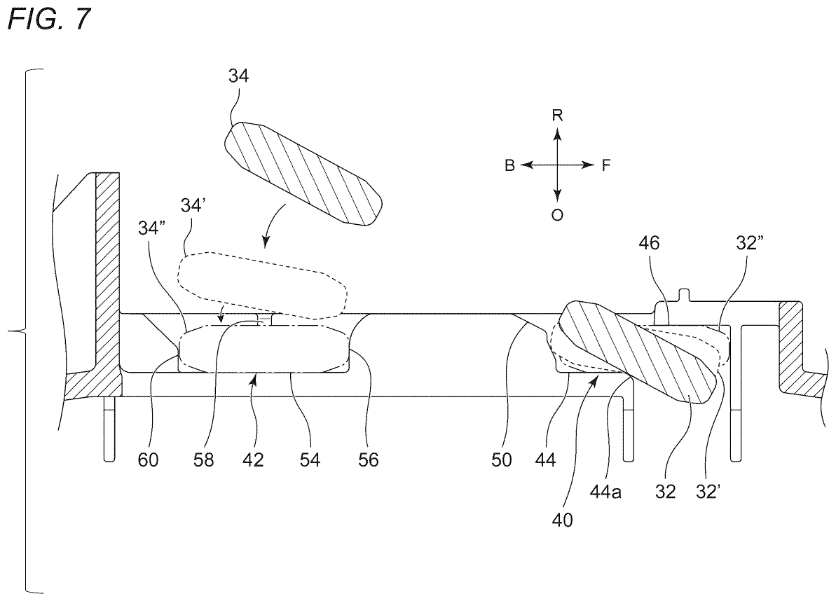

FIG. 7 is a diagram provided to explain a rotation process during the process of attaching the detection device 12 to the bracket 10. FIG. 7 shows the rotation process after the insertion process shown in FIG. 6. In FIG. 7, the first protruding portion 32 and the second protruding portion 34 are moved in order of the first protruding portion 32′ and the second protruding portion 34′, followed by the first protruding portion 32″ and the second protruding portion 34″ during the attaching process.

The first protruding portion 32 is rotated and moved in the order of the first protruding portion 32′ and the first protruding portion 32″ with the edge portion 44a as a pivot. After guiding the insertion of the first protruding portion 32, the edge portion 44a serves as a rotation pivot that rotates the first protruding portion 32 in a direction of seating the first protruding portion 32 on the first seating surface 44. Since the edge portion 44a serves as the rotation pivot as well as the guide for insertion, the detection device 12 is smoothly attached while the first protruding portion 32 is in contact with the edge portion 44a. The edge portion 44a, while guiding the first protruding portion 32 and serving as the rotation pivot, may have a shape that provides a plurality of pivots depending on the insertion angle. For example, the edge portion 44a may be a curved surface with a radius R or a tapered surface.

The first protruding portion 32 and the second protruding portion 34 are rotated and seated on the first seating surface 44 and the second seating surface 54 respectively to complete the attaching process. The first protruding portion 32 is sandwiched and held between the first seating surface 44 and the retaining portion 46. As a result, the movement of the first protruding portion 32 in the surface-rear direction O-R is restricted.

The elastic locking portion 26 is positioned at the back side in the insertion direction of the detection device 12. In the rotation process, the back portion of the main body 30 comes into contact with the elastic locking portion 26 and is bent to retract the elastic locking portion 26 backward, and when the first protruding portion 32 and the second protruding portion 34 are seated, the elastic locking portion 26 is restored and locked to the main body 30. The elastic locking portion 26 restricts the movement of the detection device 12 away from the first seating surface 44 upon completion of the attachment of the detection device 12.

The regulation portion 56 includes a curved surface 56a curved along a rotation locus of the second protruding portion 34. The second protruding portion 34 is guided by the curved surface 56a. The second protruding portion 34 is pressed by the elastic locking portion 26 to be brought into contact with the regulation portion 56. The regulation portion 56 regulates the movement of the second protruding portion 34 toward the front direction F. The first protruding portion 32 is regulated from being moved in the surface-rear direction O-R by the first holding portion 40, and the second protruding portion 34 is regulated from be moved toward the front direction F by the second holding portion 42. The regulation portion 56 can regulate the position of the second protruding portion 34, which rotates more than the first protruding portion 32 and moves significantly in the front-back direction F-B, thereby effectively regulating the movement to the front direction F.

In the rotation process, the second side surface 34a of the second protruding portion 34 comes into contact with the first rib 52. That is, the second rib 58 abuts against the second side surface 34a when the detection device 12 is rotated and attached. The position of the detection device 12 in the width direction at the back can be determined by contacting bringing the pair of second protruding portions 34 into contact with a pair of second ribs 58. The first rib 52 and the second rib 58 come into contact with the first protruding portion 32 and the second protruding portion 34 such that rattling in the width direction can be suppressed at the front portion and the back portion of the detection device 12.

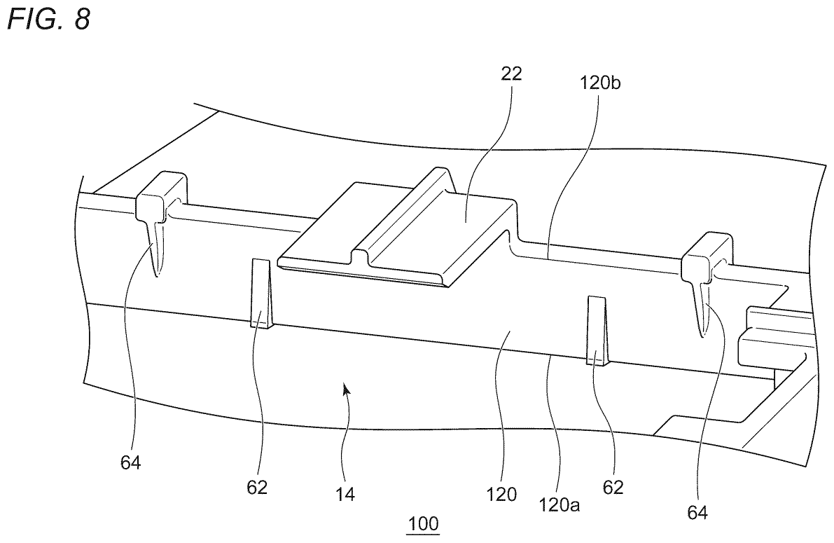

FIG. 8 is a partial perspective view of a bracket 100 according to a modification. A first protrusion 62 and a second protrusion 64 are formed in a front wall portion 120 of the bracket 100. The front wall portion 120 is positioned at a front end of the opening 14.

The first protrusion 62 and the second protrusion 64 are formed so as to protrude from the front wall portion 120. The first protrusion 62 is formed to increase a protruding height from the front wall portion 120 toward a front edge 120a of the front wall portion 120. The second protrusion 64 is formed to increase a protruding height from the front wall portion 120 toward a rear edge 120b of the front wall portion 120.

That is, the first protrusion 62 and the second protrusion 64 are formed to increase the protruding height from the front wall portion 120 toward the front edge 120a and the rear edge 120b of the front wall portion 120 respectively in the surface-rear direction O-R of the opening 14. The first protrusion 62 and the second protrusion 64 are positioned apart from each other in the width direction.

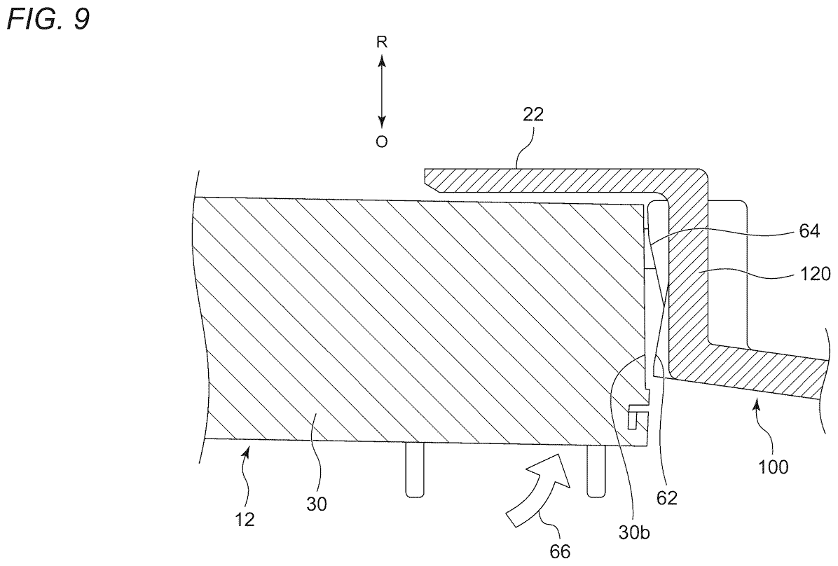

FIG. 9 is a partial cross-sectional view of the attachment structure 1 in a state in which the detection device 12 is completely attached on the bracket 100. The main body 30 is attached by moving the main body 30 in a rotation direction 66 shown in FIG. 9.

The first protrusion 62 and the second protrusion 64 serve as rotation guides for guiding rotation when the detection device 12 is rotated and attached. A front portion 30b of the main body 30 comes into contact with the first protrusion 62 to stop the insertion process and, during the rotation process, is guided by contacting from the first protrusion 62 to the second protrusion 64.

The front portion 30b is set to be spaced apart from the first protrusion 62 and the second protrusion 64 when the second protruding portion 34 comes into contact with the regulation portion 56. Further, the rear surface of the main body 30 is set to be spaced apart from the restricting portion 22 when the first protruding portion 32 comes into contact with the retaining portion 46. Although the embodiment in which the first protrusion 62 and the second protrusion 64 are positioned apart from each other in the width direction has been shown, aspects are not limited to this embodiment, and the first protrusion and the second protrusion 64 may be integrally connected.

According to the present disclosure, a bracket capable of improving the attaching workability of the detection device can be provided.

The present disclosure is not limited to each of the embodiments described above, and various modification such as design changes can be added to each embodiment based on the knowledge of a person skilled in the art, and the embodiment with such modification may also be included in the scope of the present disclosure.

What is claimed is:

1. A bracket for attaching, to a vehicle, a detection device including a main body and first protruding portions respectively formed on both sides of the main body and protruding in a width direction, the bracket comprising:
an opening configured to expose a detection surface of the detection device;
first holding portions formed in pairs on both sides of the opening and capable of holding the first protruding portions; and
a locking portion configured to lock with the main body, wherein
each of the first holding portions includes:
a first seating surface on which one of the first protruding portions can be seated; and
a retaining portion forming an insertion port in cooperation with the first seating surface for inserting a part of the one of the first protruding portions when attaching the detection device to the bracket, and capable of sandwiching and holding the one of the first protruding portions between the retaining portion and the first seating surface,
the locking portion is configured to restrict a movement of the detection device away from the first seating surface when the detection device is completely attached,
the first seating surface includes an edge portion forming a part of the insertion port, and
the edge portion is configured to guide an insertion of the one of the first protruding portions when the detection device is attached, and configured to serve as a rotation pivot for rotating the one of the first protruding portions in a direction of seating the one of the first protruding portions on the first seating surface after guiding the insertion of the one of the first protruding portions.

2. The bracket according to claim 1, further comprising second holding portions formed in pairs on both sides of the opening, and capable of holding second protruding portions respectively formed on both sides of the main body and positioned behind the first protruding portions in an insertion direction, wherein each of the second holding portions includes:
a second seating surface on which one of the second protruding portions can be seated; and
a regulation portion rising from the second seating surface and configured to regulate a movement of the one of the second protruding portions toward the insertion direction.

3. The bracket according to claim 1, wherein each of the first holding portions includes a first rib capable of contacting one of first side surfaces each of which is positioned outward in a width direction of the first protruding portions during the insertion of the one of the first protruding portions.

4. The bracket according to claim 2, wherein each of the second holding portions includes a second rib capable of contacting one of second side surfaces each of which is positioned outward in a width direction of the second protruding portions when the detection device is attached by rotation.

5. The bracket according to claim 1, further comprising:
a wall portion positioned on an insertion direction side of the opening; and
a rotation guiding portion formed so as to protrude from the wall portion and configured to guide a rotation when the detection device is rotated and attached, wherein
the rotation guiding portion includes a first protrusion and a second protrusion formed to increase a protruding height from the wall portion toward a surface side and a rear side, respectively, in a surface-rear direction through the opening.
